(19) United States
(12) Patent Application Publication
(10) Pub. No.: US 2007/0068782 A1
(43) Pub. Date: Mar. 29, 2007

(54) Pressure switches

(76) Inventor: Alan Roger Harper, Cornwall (GB)

Correspondence Address: Melvin I. Stoltz, Esq., 51 Cherry Street, Milford, CT, 06460, US

(21) Appl. No.: 11/523,852

(22) Filed: Sep. 20, 2006

(30) Foreign Application Priority Data
Sep. 28, 2005 (GB) 0519695.1

(51) Int. Cl. H01H 35/34

(52) U.S. Cl. 200/83 R

(57) ABSTRACT

The invention provides an improved pressure switch, i.e. a switch that is opened or closed in response to the presence or absence of a pressure in excess of or less than a predetermined value. The pressure switch comprises a switch body mounted on a printed circuit board, a chamber within the switch body, a switch contact plate on the printed circuit board and pressure-responsive means within the chamber that is movable into electrical contact with the switch contact plate.

### FIELD OF THE INVENTION

This invention relates to pressure switches, i.e. switches that are opened or closed in response to the presence or absence of a pressure in excess of or less than a predetermined value.

It is an object of the present invention to provide an improved form of pressure switch.

It is a more specific object of the present invention to provide a pressure switch for switching low voltage and/or low current signals that is economical to produce and operates reliably.

### SUMMARY OF THE INVENTION

According to a first aspect of the present invention there is provided a pressure switch comprising a switch body mounted on a printed circuit board, a chamber within the switch body, a switch contact plate on the printed circuit board and pressure-responsive means within the chamber that is movable into electrical contact with the switch contact plate.

The pressure-responsive means preferably comprises a flexible conductive surface, for example, a flexible metal disc.

The pressure-responsive means may be arranged to respond to an increase in pressure or to a reduction in pressure. The pressure switch may thus be a vacuum switch.

A displaceable diaphragm may be contained within the chamber and, if provided, is preferably interposed between the source of pressure and the flexible metal disc or other conductive surface.

An O-ring seal is preferably interposed between the displaceable diaphragm and the flexible metal disc or other conductive surface.

According to a second aspect of the present invention there is provided a method of generating an electrical signal from a pressure signal that comprises the use of a pressure switch as defined above.

### BRIEF DESCRIPTION OF THE DRAWING

FIG. 1 is an exploded perspective view of a pressure switch,

FIG. 2 is a sectional view of the pressure switch shown in FIG. 1,

FIG. 3 shows a vacuum switch with the switch shown in its open position, and

FIG. 4 is a sectional view of the vacuum switch of FIG. 3, with the switch in its closed condition.

### DESCRIPTION OF THE PREFERRED EMBODIMENTS

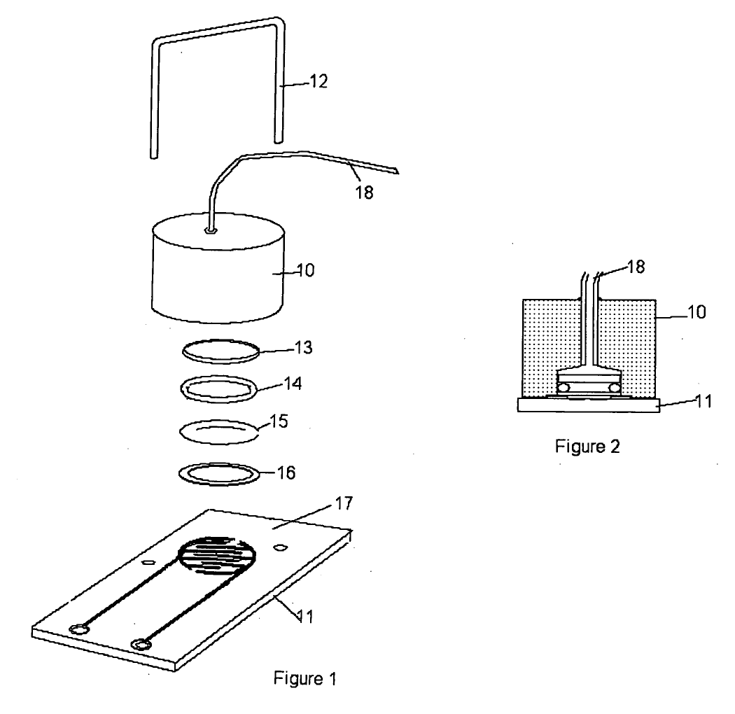

The pressure switch shown in FIGS. 1 and 2 of the drawings comprises a moulded plastic switch body 10 mounted on a printed circuit board 11 and clamped to the printed circuit board 11 by means of a tie rod 12. There is a chamber within the interior of the switch body 10 and this chamber contains a diaphragm 13, an O-ring seal 14, a membrane switch disc 15 and an insulator ring 16. There is a switch contact plate 17 that is soldered in position on the printed circuit board 11 and there is an air signal pipe 18 connected to the switch body 10 so that the pressure in the air signal pipe 18 is supplied to the chamber.

The insulator ring 16 normally maintains the membrane switch disc 15 clear of the switch contact plate 17 and the circuit containing the terminals on the printed circuit board 11 is, therefore, normally open.

When there is an increase in the pressure in the air signal pipe 18, for example, a pressure within the range of from 2 to 6 bar, the pressure acting on the upper surface of the diaphragm 13 causes the diaphragm 13 to be displaced downwardly to compress the O-ring seal 14 and to apply a pressure to the upper surface of the membrane switch disc 15, which comprises a flexible conductive metal disc. The application of pressure to the membrane switch disc 15 produces downward distortion of the central part of the disc 15 such that the disc 15 makes contact with the switch contact plate 17 to complete the circuit containing the terminals on the printed circuit board 11. Thus, when the switch senses the presence of a pneumatic pressure, for example, a normal shop air pressure within the range of from 2 to 6 bars, an electrical signal is generated.

When the air pressure is exhausted from the switch body 10 via the connecting pipe or tube 18, the resilience of the flexible membrane 15 causes it to revert to its original relaxed state and thus move away from the conductive plate 17 and thereby disconnect the electrical signal.

The particular form of switch shown in the drawings is designed to switch low voltage TTL or CMOS signals. Although the specific form of switch shown in FIGS. 1 and 2 of the drawings is designed to operate within the range of from 2 to 6 bars, it can also be used for pressures of up to 10 bar.

In addition, although the specific form of switch shown in the FIGS. 1 and 2 of the drawings is designed to sense the presence of normal shop air pressures, the invention is also applicable to the sensing of pressures in other fluids, for example, hydraulic pressures.

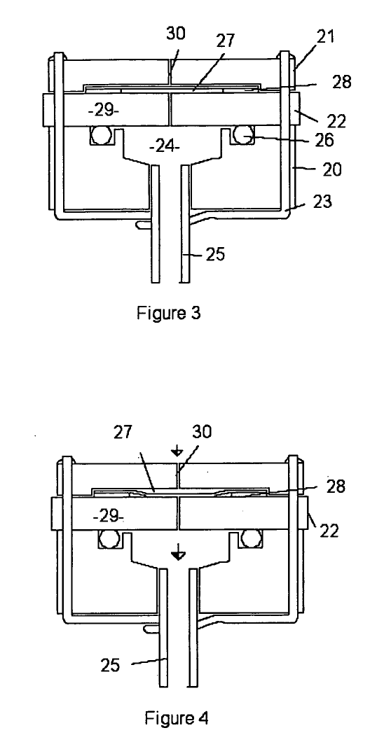

FIGS. 3 and 4 show a switch that is designed to respond to a reduction in pressure and can thus be used as a vacuum switch. It includes a housing having a main body member 20 and a top member 21 secured to a printed circuit board 22 by means of tie rods 23. There is a chamber 24 within the housing main body member 20 and this chamber 24 is connected by a line 25 to a potential vacuum source (not shown). The surface of the main body member 20 in contact with the printed circuit board 22 is formed with a circular rebate within which there is an O-ring seal 26. An airtight seal is thus provided between the printed circuit board 22 and the housing main body member 20.

The face of the housing top member 21 in contact with the printed circuit board 22 is formed with a central circular rebate within which a conductive membrane 27 is contained. There is a terminal-carrying switch contact plate (not shown) that is soldered in position on the printed circuit board 22 and the conductive membrane 27 is normally in the position shown in FIG. 3, in which it is spaced from the switch contact plate. The periphery of the conductive membrane 27 is bonded to an insulating ring 28 that, in turn, is bonded to the adjacent surface of the printed circuit board 22. There is a central hole 29 bored through the printed circuit board 22 so that the chamber 24 is in communication with the underside of the conductive membrane 27 and there is a central hole 30 drilled through the top member 21 of the housing so that the upper side of the conductive membrane 27 is in communication with the atmosphere.

The arrangement is such that, when the pressure in the line 25 falls below a predetermined value, and there is thus a predetermined difference between the pressures on the two sides of the conductive membrane 27, the central portion of the conductive membrane 27 will be deflected, as shown in FIG. 4, so that it comes into contact with the terminals of the switch contact plate on the printed circuit board 22 and thus generate an electric signal.

The design of the conductive membrane 27 and the material from which it is made will be so chosen as to ensure that the electric signal is generated whenever the pressure within the line 25 falls below a pre-selected value.

Advantages of the pressure switch of the present invention include:
a) its low cost,
b) its small size in comparison with conventional pressure switches,
c) its ability to be placed on, and soldered to, a printed circuit board,
d) its ability to be screwed into a cabinet,
e) its ability to be piped with 2 mm. outside diameter highly flexible 10 bar pneumatic pipe, that can actually be welded chemically into the cylinder and supplied to a specific cut length, and
f) it can be manufactured in multi-switch strips in the form of a an in-line bank of switches that can be designed to be used in multiples on a single strip or cut into smaller single switches or two, three or more switches.

In an alternative embodiment of the invention, the flexible diaphragm is coated on its underside with a conductive layer that thus provides the electrical contact. This removes the need for a separate membrane switch layer and insulating annulus beneath the flexible diaphragm. This alternative embodiment will thus comprise:

a connecting micro-bore pipe attached to a switch body,

a flexible one-side conductive diaphragm,

an O-ring seal,

a PCB base complete with an electrical two-pole conductive contact layer, and

a tie rod or other simple fixing means for attaching the switch body to the PCB.

In a further alternative embodiment, the pressure switch does not employ a membrane switch but, instead, includes a conductive plastic layer—approximately 1 mm. thick—that is sandwiched between the flexible diaphragm and the two-pole conductive PCB contact layer. With no applied pressure, the conductive plastic layer, or plastic “pill”, has a very high resistance. With the application of pressure to the diaphragm, the plastic pill will be squeezed against the contact layer on the PCB base. With increasing pressure, the electrical resistance of the plastic pill will decrease and the plastic pill will become an electrical conductor. Under pressurised conditions, therefore, the contacts will conduct and the circuit will change from open circuit to closed circuit conditions. The plastic pill can also be used as a proportional conductive layer such that its resistance changes from a very large value—in the megohm range—to a very small value—a fraction of an ohm depending on the size of the air pressure signal acting on the switch diaphragm.

1. A pressure switch comprising a switch body mounted on a printed circuit board, a chamber within the switch body, a switch contact plate on the printed circuit board and pressure-responsive means within the chamber that is movable into electrical contact with the switch contact plate.

2. A pressure switch as claimed in claim 1, in which the pressure-responsive means comprises a flexible conductive surface.

3. A pressure switch as claimed in claim 1, in which the pressure-responsive means comprises a flexible metal disc.

4. A pressure switch as claimed in claim 1, in which the pressure-responsive means is arranged to respond to an increase in pressure.

5. A pressure switch as claimed in claim 1, in which the pressure-responsive means is arranged to respond to a reduction in pressure.

6. A pressure switch as claimed in claim 1, in which a displaceable diaphragm is contained within the chamber and is interposed between the source of pressure and the pressure-responsive means.

7. A pressure switch as claimed in claim 5, in which an O-ring seal is interposed between the displaceable diaphragm and the pressure-responsive means.

8. A method of generating an electrical signal from a pressure signal that comprises the use of a pressure switch as claimed in claim 1.
